(19) United States
(12) Patent Application Publication
(10) Pub. No.: US 2004/0152576 A1
(43) Pub. Date: Aug. 5, 2004

(54) Cylinder for a folder unit

(76) Inventors: Simon Kostiza, Fussgonheim (DE); Viktor Cernovski, Worms (DE); Karl-Heinz Fischer, Heuchelheim (DE); Sebastian Alois Prum, Kaiserslautern (DE); Rudolf Stab, Frankenthal (DE)

Correspondence Address: Douglas R Hanscom, Jones Tullar & Cooper, Eads Station, PO Box 2266, Arlington, VA, 22202, US

(21) Appl. No.: 10/475,848

(22) PCT Filed: Apr. 4, 2002
(86) PCT No.: PCT/DE02/01219

(30) Foreign Application Priority Data
May 3, 2001 (DE) 101 21 559.2

(51) Int. Cl. B31F 1/08

(52) U.S. Cl. 493/424

(57) ABSTRACT

A collecting cylinder for a folder unit is provided with at least one disk cam that has peripheral switching depressions. These switching depressions can be covered by using an auxiliary curved trajectory which is created by a pivoting drive. Switching levers are selectively blocked or unblocked by motor-driven rotatable switching parts.

The invention relates to a cylinder for a folding apparatus in accordance with the preamble of claim 1.

A collecting cylinder is known from EP 0 436 102 A1, which has a basic cam, fixed in place on the lateral frame, for the control of the cylinder fittings and, in place of pivotable cover disks, has electro-magnetically actuable blocking bolts.

The object of the invention is based on creating a cylinder for a folding apparatus.

In accordance with the invention, this object is attained by means of the characteristics of claim 1.

The advantages to be gained by the invention rest in particular in that the switching means now employed allow short switching times, for example approximately 1/300 seconds. Because of this, the exact switching of the cylinder fittings can take place even at large circumferential speeds of the cylinder. The arrangement of a step motor in particular, together with very short switching paths generated by rotation, and the movement of small masses, is advantageous. Limitations of the switching times, switching delays, which are difficult to calculate, as well as inexact switching paths which can occur, for example, because of hysteresis properties of magnetic switching means, or the compressibility of pressure media, are prevented.

For example, it is possible by means of a collecting cylinder equipped with the above mentioned switching means to single or up to triple collections, and to set, or change, these different collecting rhythms very rapidly and without elaborate technical outlay.

The invention can be applied in connection with all fittings switchable on cylinders, such as grippers, point spurs, as well as folding jaws.

An exemplary embodiment of the invention is represented in the drawings and will be explained in greater detail in what follows. Shown are in:

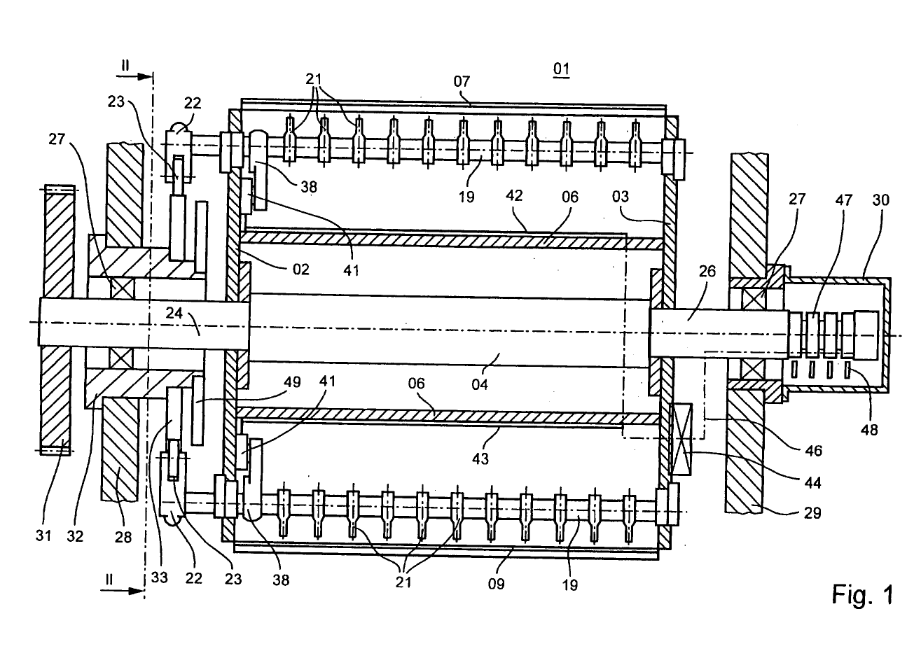

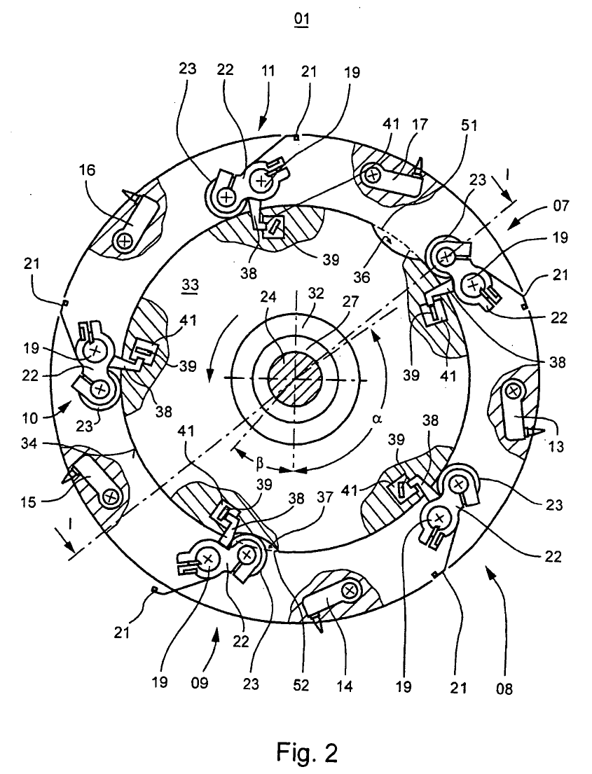

FIG. 1, a longitudinal section through a cylinder analogous to a section line I-I in FIG. 2,

FIG. 2, a cross section through a cylinder analogous to a section line II-II in FIG. 1,

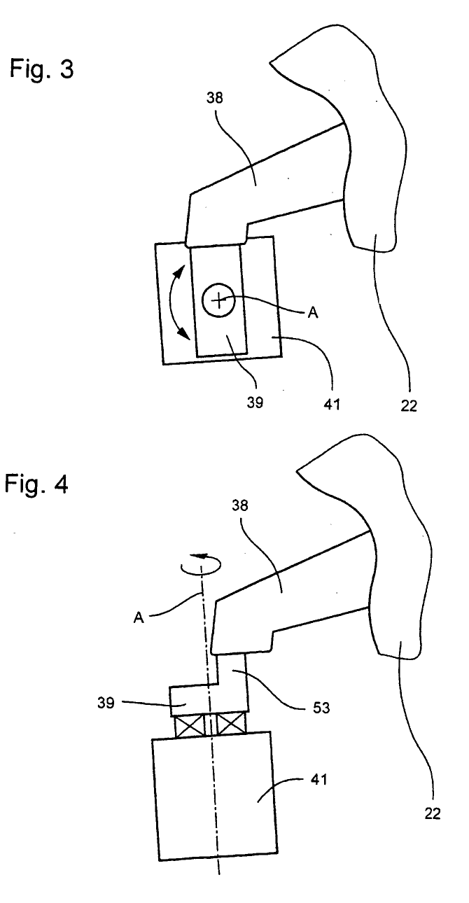

FIG. 3, a schematic representation of a drive motor with a switching element and a switching lever,

FIG. 4, a schematic representation of an embodiment variation of a drive motor with a switching element and a switching lever.

A cylinder 01, for example a five-part collecting cylinder 01 of a web-fed rotary printing press consists, for example, of two, possibly also more, lateral disks 02, 03 arranged on a shaft 04 and separated from each other by cross pieces 06, if required. The cylinder 01 has cylinder fittings 07, 08, 09, 10, 11, 13, 14, 15, 16, 17 on its circumference, for example five gripper systems 07, 08, 09, 10, 11, which are spaced apart from each other and between each of which folding blade systems 13, 14, 15, 16, 17, only suggested or symbolically represented, are arranged (FIG. 2).

Each one of the gripper systems 07 to 11 has a support spindle 19, which is rotatably seated between the lateral disks 02, 03, with grippers 21 arranged, fixed against relative rotation, on the support spindle 19 and spaced apart over the cylinder width, which can be moved against a gripper rest, not represented.

On one end, the support spindle 19 has a roller lever 22. The latter receives a roller 23 on its second end.

The collecting cylinder 01 is seated in lateral frames 28, 29 by means of its shaft journals 24, 26 and various bearings 27, for example rolling bearings 27. The left shaft journal 24 is connected with a gear wheel 31, for example a drive gear wheel 31.

A bushing 32, fixed in place in the lateral frame, which receives the left rolling bearing 27, as well as the shaft journal 24 located therein, is arranged on the driven side, i.e. in the left lateral frame 28. This bushing 22 supports at least one base cam disk 33, which is arranged parallel in respect to the lateral frame between the lateral frame 28 and the lateral disk 02, and on whose periphery 34 the rollers 23 of the gripper systems 07 to 11 roll off.

On its periphery 34, the base cam disk 33 has various troughs 36, 37, for example a receiving trough 36, as well as a delivery trough 37.

On the end of its support spindle 19, each one of the cylinder fittings 07 to 11, i.e. each one of the gripper systems 07 to 11, has a switching lever 38, which is fixed on the support spindle and extends approximately in the radial direction in respect to the shaft 04. The switching lever 38 can extend in the interior of the cylinder in the vicinity of the lateral disk 02. The free end of the switching lever 38 can enter into a connection with a cam-like or propeller-shaped switching element 39, which is rotatable around an axis of rotation A by means of a drive motor 41 fixed in place on the lateral frame. In an advantageous embodiment the switching element 39 is connected, fixed against relative rotation, with the motor shaft of the drive motor 41. The drive motor 41 is advantageously designed as a step motor 41. The switching element 39 is designed as a one-armed or double-armed lever 39, for example, wherein the free end can be used as a stop for the free end of the switching lever 38 and can block it (FIGS. 3, 4).

Each one of the drive motors 41 assigned to the individual gripper systems 07 to 11 is connected by means of lines 42, 43 with an electrical control unit 44 located, for example, on the exterior of the lateral disk 03. This control unit 44 is connected by means of a line 46 extending over the right shaft journal 26 with a collector ring body 47, which is located on the shaft journal 47 and enclosed in a housing 30. The output lines 48 of the collector rings lead to a central control device, not represented.

It is of course also possible to arrange a rotatable transmitter unit, not represented, in place of the collector ring body 47, and to transmit the control signals in a contactless manner via a stator, also not represented, to the central control device, and to receive fresh control signals from the latter.

It is furthermore possible to arrange a second base cam disk 49 for the folding blade systems 13 to 17 on the bushing 32, fixed in place on the lateral frame. Parts of this are moreover rollers and roller levers, not represented. As in connection with the gripper systems 07 to 11, switching levers, switching elements, as well as step motors, not represented here, are also provided for the folding blade systems 13 to 17. The embodiment of the lateral disks 02, 03 as multi-piece lateral disks 02, 03 is advantageous, wherein the folding blade systems 13 to 17 and the gripper systems 07 to 11 can be rotated in respect to each other. In this embodiment the shaft journal 24 is advantageously embodied as a hollow shaft and is connected, for example, with the lateral disk 02 for the support spindle 19 of the gripper systems 07 to 11. For example, the shaft journal, not represented, of the lateral disk, also not represented, of the folding blade systems 13 to 17 is arranged inside the shaft journal 24 embodied as a hollow shaft.

The systems of the cylinder 01 operate as follows:

In accordance with the control signals received via the control unit, the drive motors 41 are each actuated by the rotation of their motor shafts in such a way that the free end of the propeller-shaped switching element 39 is brought into a tangential position in respect to the cylinder cross section—see the gripper system 07—or into a radial position in respect to the cylinder cross section—see the gripper system 09—. The gripper system 08 shows the switching element 39 within a switching angle alpha, while the gripper system 09 shows the switching element 39 in a resting phase within an angle beta. At high numbers of revolutions of the collecting cylinder 01, along with high circumferential speeds, the switching element 39 must arrive in its new position within the switching angle alpha very quickly, in particular within a time of less than 1/300 second, and dependably.

In the tangential position the switching lever 38 of the support spindle 19 is blocked, in this case the rollers 23 cannot dip into the trough 36. An auxiliary cam track 51 is created, which prevents the opening of the gripper systems 07 to 11 when the rollers 23 pass through.

In the radial position of the switching element 39—see the gripper system 09—the roller 23 passes through the delivery trough 37 and the grippers 21 open. In the tangential position of this switching element 39, an auxiliary cam track 52 would be created for the rollers 23, and the delivery of imprinted products would be prevented by this. In this case the axis of rotation A of the switching element 39 which, in the present case, is congruent with the motor shaft of the drive motor 41, extends axis-parallel in respect to the support spindle 19.

The same applies in connection with the folding blade systems 13 to 17, not represented in detail here.

In accordance with an embodiment variation it is also possible for a free end of the rotatable lever 39 of the switching element 39 to have a cam 53, which extends almost at right angles to the switching element 39 and axis-parallel with the axis of rotation A of the switching element 39, or the motor shaft, and which, in a blocking position, is rotated underneath the free end of the switching lever 38 and blocks it, so that the support spindle 19 is also not rotatable because of this (FIG. 4).

In this case the motor shaft of the drive motor 41 extends in a secant-like direction in respect to the cylinder cross section in accordance with FIG. 2.

It is moreover also possible to employ lifting magnets, not represented, for switching the systems, for example for opening and closing the gripper systems 07 to 11, in place of the previously mentioned drive motors 41.

The switching lever 38 can also be brought into two different positions by the different placement of the lifting drive.

The generation of the auxiliary cam tracks 51, 52 can be employed in the same or similar manner for cylinders for cutting or folding.

List of Reference Symbols

01 Cylinder, collecting cylinder

02 Lateral disk (01)

03 Lateral disk (01)

04 Shaft (01)

05 -

06 Cross piece (02, 03)

07 Cylinder fitting, gripper system (01)

08 Cylinder fitting, gripper system (01)

09 Cylinder fitting, gripper system (01)

10 Cylinder fitting, gripper system (01)

11 Cylinder fitting, gripper system (01)

12 -

13 Cylinder fitting, folding blade system (01)

14 Cylinder fitting, folding blade system (01)

15 Cylinder fitting, folding blade system (01)

16 Cylinder fitting, folding blade system (01)

17 Cylinder fitting, folding blade system (01)

18 -

19 Support spindle (07 to 11)

20 -

21 Gripper (07 to 11)

22 Roller lever (23, 19)

23 Roller (22)

24 Shaft journal (01)

25 -

26 Shaft journal (01)

27 Bearing, rolling bearing

28 Lateral frame

29 Lateral frame

30 Housing (47)

31 Gear wheel, drive gear wheel (01)

32 Bushing (28)

33 Base cam disk (32)

34 Periphery (33)

35 -

36 Trough, receiving trough (34)

37 Trough, delivery trough (34)

38 Switching lever (19)

39 Switching element, lever, one-armed

40 -

41 Drive motor, step motor

42 Line (41, 44)

43 Line (41, 44)

44 Control unit (01)

45 -

46 Line

47 Collector ring body (26)

48 Output line

49 Base cam disk (32)

50 -

51 Auxiliary cam track (36)

52 Auxiliary cam track (37)

53 Cam

A Axis of rotation (39)

alpha Switching angle

beta Angle, resting phase

1. A cylinder of a folding apparatus using rollers (23), which run on at least one base cam disk (33, 49) arranged fixed on the lateral frame and having troughs (36, 37), and which are maintained in roller levers (22), for switching cylinder fittings (05 to 11, 13 to 17), wherein an auxiliary cam path (51, 52), which covers the troughs (36, 37) in the base cam disk (33, 49) can be created by means of a switching element (39) which selectively blocks or unblocks the roller lever (22), wherein the switching element (39) is arranged on the rotating cylinder, characterized in that the roller lever (22) can be selectively blocked or unblocked by means of a rotary movement of the switching element (39) around an axis of rotation (A), and that the switching element (39) can be driven by means of a drive motor (41).

2. The cylinder in accordance with claim 1, characterized in that the axis of rotation (A) of the switching element (39) extends parallel in respect to the motor shaft of the drive motor (41).

3. The cylinder in accordance with claim 1, characterized in that the drive motor (41) is embodied as a step motor (41).

4. The cylinder in accordance with claim 1, characterized in that during the blockage the switching element (39) works together with and acts as a stop for the switching lever (38), which is fixed in place on the support spindle.

5. The cylinder in accordance with claim 1, characterized in that the drive motor (41) is connected by means of lines (42, 43) with a rotatable control unit (44) fixed in place on the cylinder.

6. The cylinder in accordance with claim 5, characterized in that the rotatable control unit (44) fixed in place on the cylinder is connected in a contactless manner with a stator, which receives the control signals from a central control device.

7. The cylinder in accordance with claim 1, characterized in that the switching element (39) is embodied as a circularly pivotable, at least one-armed lever (39) which, in the blocking position, blocks the free end of the switching lever (38) with a free end as the stop, and that the axis of rotation (A) of the switching element (39) extends nearly axis-parallel in respect to the support spindle (19).

8. The cylinder in accordance with claim 1, characterized in that the switching element (39) is embodied as a circularly pivotable, at least one-armed lever (39), which has on its free end a cam (53) extending axis-parallel with the motor shaft of the drive motor (41) and points in the direction toward the switching lever (38), and which, in a blocking position, extends in the manner of a stop underneath the free end of the switching lever (38) and blocks it, and that the axis of rotation (A) of the switching element (39) extends in almost a secant-like direction in respect to the cross section of the cylinder (01).

9. The cylinder in accordance with one of claims 7 or 8, characterized in that the switching element (39) is arranged on the motor shaft, or on a shaft which lengthens the motor shaft, and that the axis of rotation (D) of the switching element (39) is identical with the motor axis.
